(19) United States
(12) Patent Application Publication
(10) Pub. No.: US 2003/0045268 A1
(43) Pub. Date: Mar. 6, 2003

(54) Telephone service with variable party billing

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/942,746

(22) Filed: Aug. 30, 2001

(51) Int. Cl. H04M 11/00

(52) U.S. Cl. 455/408; 455/406

(57) ABSTRACT

A method, computer program product, and data processing system for specifying a party to be billed for the entirety of mobile telephone airtime and other charges in a telephone conversation is disclosed. Either the caller or a called party may accept all airtime and/or other charges. In addition, the parties need not operate a mobile telephone, but may use a conventional “wire” telephone.

### BACKGROUND OF THE INVENTION

1. Technical Field

The present invention is directed generally toward administering a mobile telephone service. More specifically, the present invention is directed toward allowing a change in the billed party in a mobile telephone call.

2. Description of Related Art

The mobile telephone has ushered in a new era in interpersonal communications. While the late 1990s' widespread consumer interest in the Internet made ours a wired world, technical advances and increased consumer appeal are ushering in a new “wireless world.” A number of mobile telephone manufacturers and service providers cater to a growing base of mobile telephone subscribers. Unlike most local telephone service in the United States, but akin to long-distance service, mobile telephone service is usually billed in minutes of airtime. That is, the amount a customer is charged is proportional to the amount of time spent in mobile telephone calls. For instance, a five minute call will usually cost five times as much as a one minute call. Unlike with long-distance service, however, airtime is generally billed to the customer regardless of whether the customer placed or received the call.

Because having every minute of every call charged for is a major discouragement to consumers wishing to use mobile telephones, mobile service providers often employ a billing system in which customers pre-pay for a certain number of minutes of airtime each month. When a customer makes a call, the minutes of airtime are subtracted from the customer's balance of minutes for the month. Any additional minutes exceeding the customer's pre-paid balance are billed for separately. In most billing schemes, the current month's minutes expire at the end of the month if not used.

Thus, many mobile telephone customers pay for their telephone usage by redeeming pre-paid credits (measured in minutes of airtime). This scheme has many analogs in other areas of business. For instance, most individuals will mail a letter by first buying a pre-paid postage credit (i.e., a postage stamp), then redeeming the credit (i.e., mailing the letter with the stamp attached). Nonetheless, the problem of billing mobile telephone customers for the calls they receive remains. The fact that a caller knows that the party she is calling will be charged for the call can be a major discouragement to calling that person's mobile telephone number. Likewise, someone who has asked a mobile telephone user to call him may wish to be billed for the caller's airtime, rather than make the caller pay for a call the called party requested. Thus, it would be beneficial if there were a way for a party to a mobile telephone conversation to be billed for the entirety of the airtime.

### SUMMARY OF THE INVENTION

The present invention provides a method, computer program product, and data processing system for specifying a party to be billed for the entirety of mobile telephone airtime and other charges in a telephone conversation. Either the caller or a called party may accept all airtime and/or other charges. In addition, the parties need not operate a mobile telephone, but may use a conventional “wire” telephone.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is a diagram of a mobile telephone with which the processes of the present invention may be implemented;

FIG. 1B is a block diagram of a mobile telephone with which the processes of the present invention may be implemented;

FIG. 2 is a diagram of the operation of a mobile telephone system in which the present invention may be implemented;

FIG. 3 is a block diagram of a data processing system in which the processes of the present invention may be executed;

FIG. 4 is a diagram of a database holding information about mobile telephone subscribers in a preferred embodiment of the present invention;

FIG. 5 is a diagram of a process of specifying the party to be billed for mobile airtime minutes in accordance with a preferred embodiment of the present invention;

FIG. 6 is a flowchart representation of a process of specifying a billed party in accordance with a preferred embodiment of the present invention;

FIG. 7 is a diagram depicting a process of accepting airtime charges in a call in progress; and

FIG. 8 is a flowchart representation of a process for accepting airtime charges for a call in progress.

### DETAILED DESCRIPTION OF THE PREFERRED EMBODIMENT

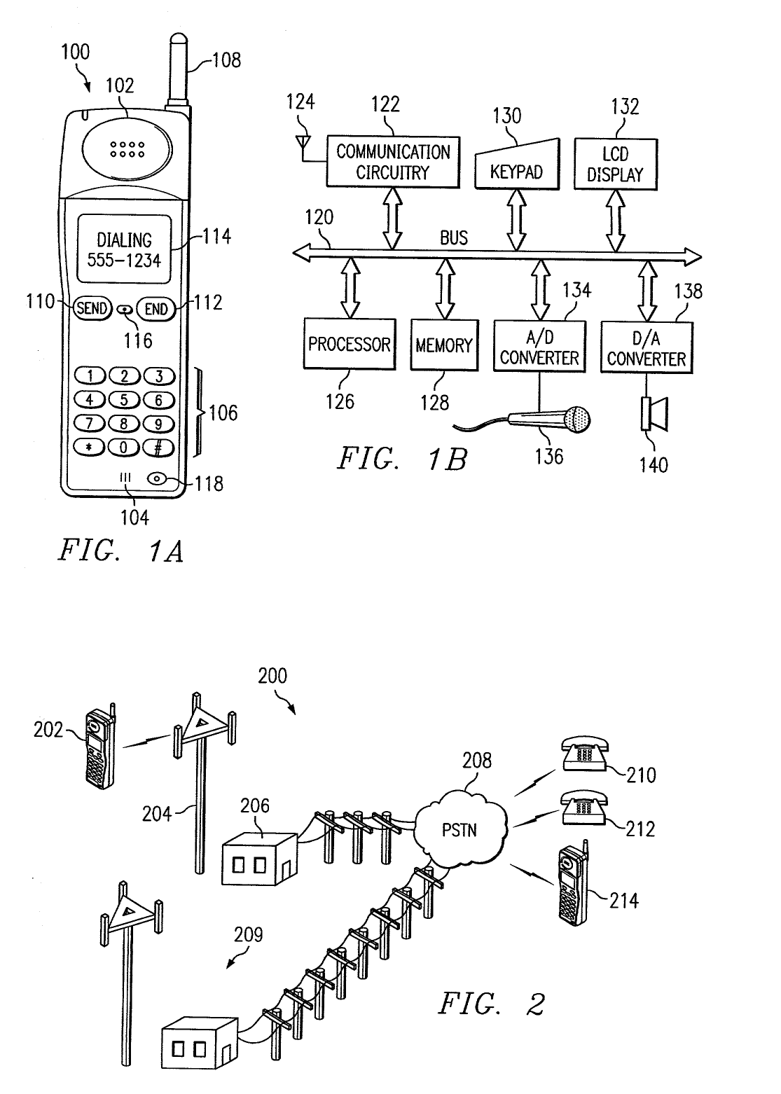

FIG. 1 depicts an exemplary mobile telephone 100 with which the processes of the present invention can be implemented. Mobile telephone 100, for instance, could be a Talkabout® T8167 Mobile Telephone from Motorola, Inc. of Schaumberg, 111. Like a conventional telephone, mobile telephone 100 contains an earpiece 102, a microphone 104, and a keypad 106 for emitting DTMF (Dual-Tone Multiple Frequency) tones for dialing. Mobile telephone 100, unlike a conventional telephone, uses an antenna 108 as its communications link to the Public Switched Telephone Network (PSTN), the standard public telephone network through which most telephone calls are routed. Mobile telephone 100 may transmit and receive data, including but not limited to voice data, through an analog-coded or digitally coded signal. One common communications standard for mobile telephones is the PCS (Personal Communications Services) standard, which uses digital signal coding. Some mobile telephones, such as dual-band mobile telephones, will allow multiple communications standards to be used with the same telephone; this is a convenience, particularly in remote areas where some communications protocols are not available.

Mobile telephone 100 includes a “send” button 110 and an “end” 112 button for initiating and terminating calls, respectively. To dial another telephone, a user enters the telephone number for that telephone on keypad 106 and presses “send” button 110 to place the call. To “hang up” or terminate the call, the user presses “end” button 112.

Mobile telephone 100 also includes a liquid-crystal display (LCD) 114 for indicating to a user the status of mobile telephone 100, such as when mobile telephone 100 is dialing. In some mobile telephones, display 114 may be used for executing software, such as games, or for browsing World Wide Web documents loaded from the Internet through a wireless connection using antenna 108. A user of mobile telephone 100 will generally rely on a service provider to provide a wireless gateway into the PSTN. In addition to allowing a user to send and receive telephone calls, a service provider may provide additional features to customers. One of these features, as was already mentioned, is wireless Internet access. Another is voice mail. If the user of the mobile telephone 100 is unavailable (i.e., has turned off mobile telephone 100, is already talking to someone using mobile telephone 100, or simply ignores the ringing mobile telephone 100), a caller calling mobile telephone 100 can be switched into a voice mail service, where the caller can leave a message for the user of mobile telephone 100. An indicator, such as an envelope icon, can appear in display 114. The user of mobile telephone 100 can later access the voice mail service by pressing a special voice-mail button 116 or by calling a special telephone number (such as *123, for instance) or by calling the user's own number. The user can then use keypad 106 to enter DTMF tones to select recited voice mail menu options.

Mobile telephone 100 will generally run on some kind of battery power using a rechargeable battery pack, or the like. To conserve energy when mobile telephone 100 is not needed, power button 118 may be used to turn off and later turn on mobile telephone 100. When mobile telephone 100 is turned off, it cannot send or receive calls, although voice mail services are still available. FIG. 1B is a block diagram of mobile telephone 100. Bus 120 provides the central backbone through which the electronic components of mobile telephone 100 communicate.

Attached to bus 120 is a communications circuitry module which transmits and receives mobile telephone signals through antenna 124 using one of a number of transmission and multiplexing schemes available for wireless communications including, but not limited to, FDMA (frequency division multiple access), TDMA (time division multiple access), CDMA (code division multiple access), and GSM (global system for mobile communications).

Communications circuitry module 122 and other components of mobile telephone 100 are controlled by processor 126 which may be a general-purpose microprocessor, such as a PowerPC microprocessor, or a digital signal processor or other specialized processor. Processor 126 executes program code stored in memory 128 to direct the operation of mobile telephone 100. Processor 126 also uses memory 128 to store data, such as frequently-dialed telephone numbers.

A variety of input-output (I/O) components communicate with processor 126 through bus 120, including keypad 130 and liquid-crystal diode (LCD) display 132. Analog-to-digital converter 134 takes analog audio information from microphone 136 and converts it to a digital data representation for transmission over bus 120. Likewise digital-to-analog converter 138 takes digital data from bus 120 and converts it into audio for presentation through earpiece speaker element 140. All of these I/O components communicate with and are coordinated by processor 126. For example, digital audio data created by analog-to-digital converter 134 is retrieved by processor 126, prepared for transmission by processor 126, and then sent to communications circuitry module 122 for transmission over antenna 124. To take another example, a telephone number entered by a user using keypad 130 is retrieved by processor 126, which generates DTMF tones for transmission by communications circuitry module 122. Processor 126 then displays the entered telephone number on LCD display 132 to the user. FIG. 2 is a diagram depicting the operation of a mobile telephone 202 within a telephone system 200. Mobile telephone 202 communicates with radio tower 204, sending and receiving voice and other data, such as Internet data. Service provider facility 206 connects control tower 204 with Public Switched Telephone Network (PSTN) 208. Service provider facility 206 also performs such tasks as recording the number of minutes mobile telephone 202 stays connected on a call and providing voice mail and Internet services. PSTN 208 connects service provider facility 206 with other communications devices such as telephones 210 and 212 and (by way of a service provider and radio tower) mobile telephone 214. One of ordinary skill in the art will recognize that many communications devices that are not telephones may be connected to PSTN 208 and thus accessible by mobile telephone 202.

One of ordinary skill in the art will also recognize that multiple service providers may be present within the same geographic area. In the diagram, service provider facility 209 represents an additional service provider in competition with the operators of service provider facility 206.

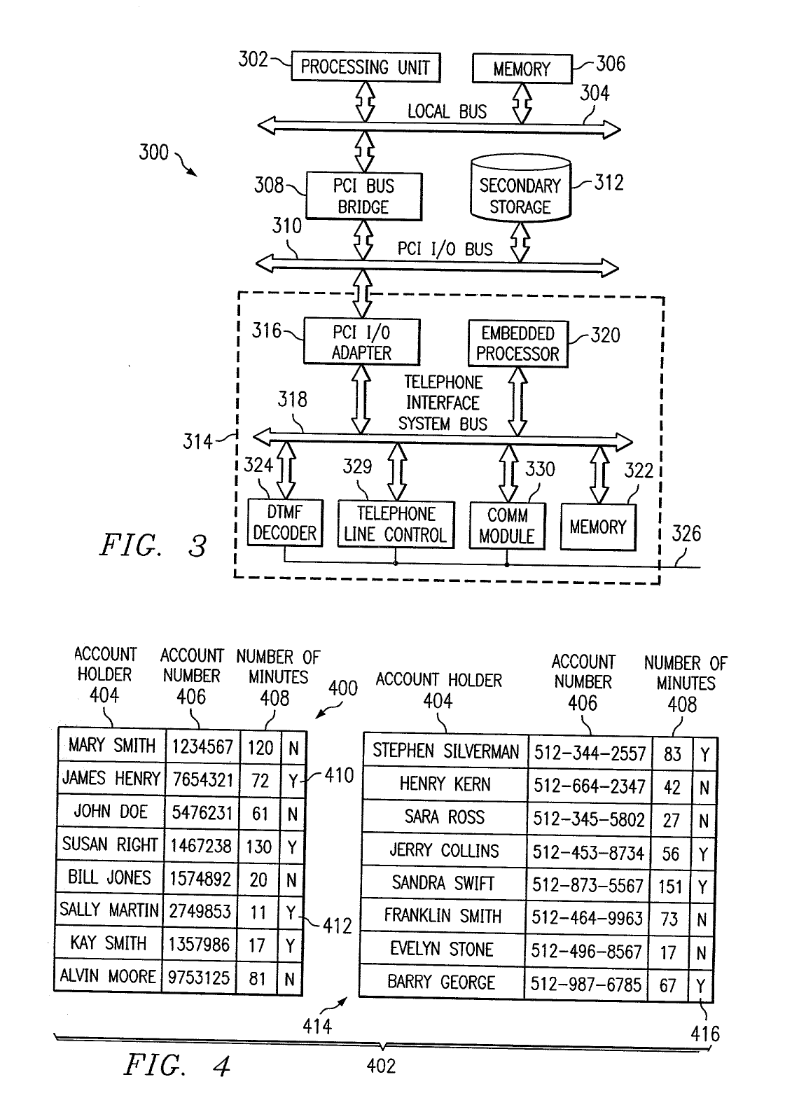

FIG. 3 is a block diagram of a data processing system 300 in which the processes and computer program product instructions of a preferred embodiment of the present invention may be implemented. Preferably data processing system 300 will be associated with equipment operated by a mobile telephone service provider. For example, data processing system 300 may be associated or located in service provider facility 206 in FIG. 2.

Data processing system 300 includes a (central) processing unit 302 connected to a local bus 304. Processing unit 302 executes instructions stored in memory 306, which is also connected to local bus 304. Processing unit 302 may comprise a single processor, such a microprocessor, or it may comprise multiple processors so as to allow the execution of multiple instructions simultaneously. Any number of processors could be used in processing unit 302. An example of a suitable processor is the PowerPC microprocessor, developed by IBM Corporation of Armonk, N.Y.

Many different types of memory are available and suitable for use within data processing system 300. Memory is generally classified as volatile and non-volatile memory. Volatile memory types store data temporarily while the data processing system is operating, but lose their data once the data processing system's power is turned off. Most volatile memory in use today is “random access memory,” (RAM) meaning that data and instructions may be read from or written to any portion of the memory at any time. Common random access memory types well-known to those skilled in the art include static random access memory (SRAM) and dynamic random access memory (DRAM). Non-volatile memory types retain their information, even when the data processing system is turned off. Non-volatile memory types are generally referred to as “read-only memories” (ROM). Many types of non-volatile memories exist. Programmable read-only memory (PROM) may be programmed with permanent data using a PROM programming device. Erasable programmable read-only memory (EPROM) can be erased of its data contents, through such means as ultraviolet radiation or through electric current (as with an electrically-erasable PROM or EEPROM). Flash memory and non-volatile random-access memory (NVRAM) are two memory media that may be written to and erased within working circuits without the use of a memory programming device.

Memory 306 may store data to be operated upon by processing unit 302, it may store instructions to be executed by processing unit 302, or it may store both.

In FIG. 3, a single memory module is depicted, although many memory arrangements are possible. Cache memory, which is a high speed memory used for temporary storage of data and instructions to be stored to read from a primary bank of memory may be used. Also, certain systems designed with what is known as a “Harvard architecture” use separate memory and buses for data and instructions.

PCI bus bridge 308 connects local bus 304 to PCI input/output (I/O) bus 310. PCI I/O bus 310 is what is known as a backplane bus. A backplane bus is not connected directly to a central processing unit, but communicates with the central processing unit via a bus bridge. Peripheral devices, such as disk drives and other input/output and storage devices typically connect to backplane buses. Having a separate backplane bus prevents peripheral device malfunctions from interrupting the operation of the central processing unit (processing unit 302).

Secondary storage 312 is connected to PCI I/O bus 310. Secondary storage 312 may comprise one or more disk drives, magnetic tape drives, optical storage devices, or other persistent storage medium. Secondary storage 312 preferably stores relatively large amounts of data and instructions compared to memory 306. Secondary storage 312 may be used for permanent storage of data or instructions, such as a database, or secondary storage 312 may be used to supplement memory 306 with additional storage space. One common method of providing additional storage space to augment memory 306, called virtual memory, involves swapping portions of data, called pages, between memory 306 and secondary storage 312 such that pages are addressed and located in memory 306 when in use, but swapped out to secondary storage 312 when not in use. Also connected to PCI I/O bus 310 is a telephone interface device 314. Telephone interface device 314 includes a PCI I/O adapter 316 connected to PCI I/O bus 310. PCI I/O adapter 316 allows telephone interface device 314 to communicate through PCI I/O bus 310. PCI I/O adapter 316 is connected to telephone interface system bus 318, which connects the various components of telephone interface device 314. An embedded processor 320 is preferably some sort of microprocessor, such as a Z80 microprocessor, manufactured by Zilog, Inc. Embedded processor 320 executes instructions stored in memory 322, which is also attached to telephone interface system bus 318. Embedded processor 320 interprets commands communicated through PCI I/O adapter 316 and, in response, directs the operation of telephone interface device 314. Embedded processor 320 operates on data, which it stores and retrieves in memory 322. Alternatively, a microcontroller, such as an 8051 microcontroller, manufactured by Intel Corporation, could be used in place of embedded processor 320 and memory 322. A microcontroller is a monolithic integrated circuit containing both a processor unit and memory. Dual Tone Multiple Frequency (DTMF) decoder 324 interprets DTMF tones from telephone network line 326, translating the tones into corresponding numbers from a telephone keypad. DTMF decoders are available as monolithic integrated circuits from a number of vendors. DTMF decoder 324 reports the numeric interpretation of the DTMF tones to embedded processor 320 through telephone interface system bus 318.

Telephone network line 326 can be connected directly into the Public Switched Telephone Network, perhaps using a DSL (Digital Subscriber Line) modem. It may also be connected through a local-area network (LAN) using, for example, an RJ45 modular connector for an Ethernet LAN, perhaps connected to a T1 line (a high-bandwidth network line). Although a standard analog telephone line may be used, a more likely option would be utilize a digital telephone line instead.

Telephone line control system 329 acts under the control of embedded processor 320 to “pick up” or “hang up” telephone network line 326. Telephone line control system 329 also detects when telephone network line 326 is “ringing.”

Embedded processor 320 transmits audio messages across telephone network line 326 by transmitting digital audio data (which may include voice, indicator chimes, DTMF signals, or any other audio signal) from memory 322 through communication module 330.

FIG. 4 is a diagram depicting the format of a account information database stored within secondary storage 312 of FIG. 3 in a preferred embodiment of the present invention. Table 400 includes entries 402 for each of the customers of a mobile telephone service provider. Account holder field 404 stores the name or identity of each customer. Account number field 406 stores an account number for each customer, which may the customer's telephone number. Minute balance field 408 stores each customer's balance of remaining call minutes. Table 414 stores entries for another telephone company, which may or may not be a mobile telephone customer. The present invention provides a method, computer programming product, and apparatus for changing the billing of airtime minutes for a call from one billed party to another. In a preferred embodiment, for instance, the mobile telephone customer whose entry is 410 may be engaged in a telephone conversation with a telephone customer who is using a different telephone service provider (414) and whose entry is 416 (the customer in entry 416 need not be a mobile telephone customer). The customer in entry 416 may accept the airtime or other charges for the customer in entry 410 in addition to any charges the customer in entry 416 may incur for the call; thus, entry 416 will have airtime minutes deducted from entry 416's balance of remaining minutes to pay for the telephone charges of the customer in entry 410. Other charges, such as long distance charges or local telephone provider charges may be accepted on behalf of another party as well.

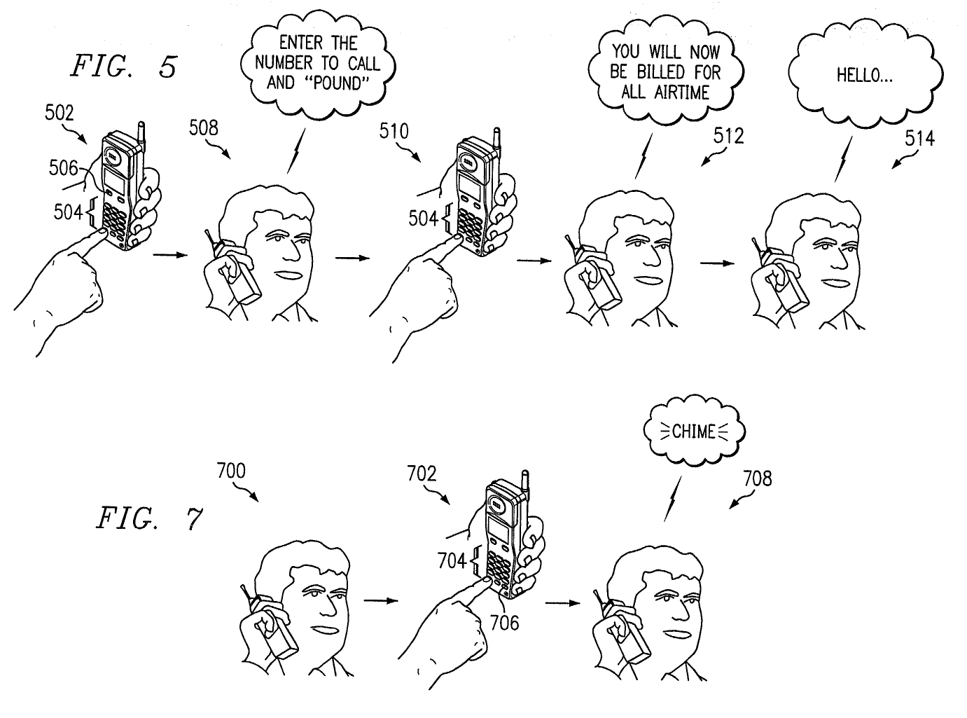

Note that FIG. 4 depicts a pre-paid billing arrangement. The processes of the present invention are equally applicable when a customer accrues charges and pays them off after they have accrued. In such a case, instead of a minute balance being deducted from, an accounts receivable figure will be incremented. FIG. 5 provides a story board representation of a process of a caller accepting the called party's airtime charges in a preferred embodiment of the present invention. Note that although the caller in FIG. 5 is using a mobile telephone, only the called party need be using a mobile telephone; the caller may use any type of telephone. In step 502, the customer transferring the minutes dials a telephone number or access code (such as *123) for the variable billing function, on keypad 504. Then the customer presses “Send” button 506 to initiate a call to the service. A call is connected to data processing system 300, as described in FIG. 3. In step 508, data processing system 300 answers the call and plays a recorded message through digital to analog converter 330, asking for the called party's telephone number.

In step 510, the customer enters the recipient's telephone number and the “#” (pound) key on keypad 504, which causes DTMF tones to be produced and transmitted to data processing system 300. Data processing system 300 then decodes the DTMF tones to recover the entered digits. Next, in step 512, the customer is given a confirmation message telling that the caller will be billed for the called party's airtime. Finally, in step 514, the call is connected.

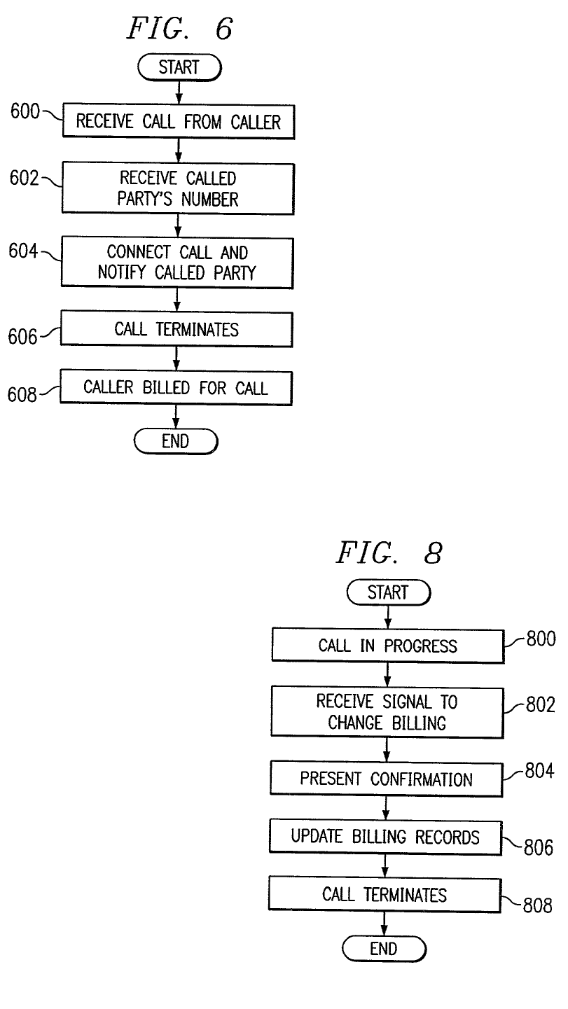

FIG. 6 is a flowchart representation of a process of a caller accepting the airtime charges for the called party in a preferred embodiment of the present invention. First, a call to mobile phone service provider equipment is received (step 600). The called party's telephone number is received (step 602). Then, the call is placed and the called party is notified that the call will be paid for by the caller, perhaps with an indicator associated with caller ID (step 604). The call is terminated at the end of the conversation (step 606).

Finally, customer records are updated to reflect that the caller has been billed for the call (step 608). FIG. 7 is a diagram depicting a party to a conversation's acceptance of the other party's airtime charges. In step 700, the accepting party carries on a conversation with another party; the other party is talking on a mobile telephone. In step 702, the accepting party presses a key on telephone keypad 704(in this case, “#” key 706), which signals the accepting party's telephone service provider to allow the accepting party to assume the airtime charges for the other party. In step 708, a chime is played over the earpiece of the telephone and is audible to both parties to signify that the accepting party has accepted the other party's airtime charges. Note that the accepting party need not be using a mobile telephone.

FIG. 8 is a flowchart representation of a process of accepting airtime charges for another party in accordance with a preferred embodiment of the present invention. First, the parties must be in communication with one another (step 800). Next, the accepting party actuates a control on his or her telephone to signify that the accepting party wishes to assume the airtime and/or other charges (step 802). A confirmation is presented to the parties (step 804). The billing records are updated to show that the accepting party has accepted the already accrued charges, and as the call transpires, the records continue to be updated so as to bill the accepting party for the entirety of the call (step 806). Finally, the call terminates (step 808).

One of ordinary skill in the art will recognize that a number of variations of the present invention exist. For instance, one particularly useful feature that could be added to the embodiment herein described would be a notification to the non-billed party that the billed party has accepted all airtime charges. The notification may be as simple as a chime played in the earpiece of the non-billed party's telephone. It may be a text message or icon transmitted and displayed on display 114 (FIG. 1) along with the billed party's telephone number or sent via instant messaging for example.

The variable party billing service need not be free of charge. Mobile telephone service providers could charge a transaction fee for overriding the default billing. They could also offer the ability to make (free or for fee) billing overrides as a premium telephone service. Another possible variation on the present invention involves billing arrangements between customers having different telephone service providers. Service providers would enter into reciprocal agreements to allow billing overrides with different service providers. Service providers would agree to exchange rates, wherein airtime minutes from one service provider would have a relative value vis-à-vis services or features from another service provider. For example, two service providers (A and B) may agree to allow billing overrides between the two service providers with an exchange rate of 3 minutes of A for every 2 minutes of B. Accordingly, a customer of B could be billed for 100 minutes of airtime by a customer of A. The customer of B would then be billed for only 67 minutes, due to the exchange rate between A and B. Another variation involves no affirmative act to change the billed party. Much like toll-free numbers (e.g., “1-800 numbers” in the United States), dedicated free-airtime telephone numbers can be established, whereby anyone who calls one of these free-airtime telephone numbers will have his or her airtime billing and/or other charges assumed by the holder of the free-airtime number. The holder of a free-airtime telephone number could either be billed for the actual airtime or billed at a flat periodic (e.g., monthly) rate for the use of a free-airtime number.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method operative with respect to a telephone conversation having at least one party operating a mobile telephone, the method comprising:
writing data to a billing record to indicate that a second party has been billed for mobile telephone airtime charges of the at least one party operating a mobile telephone, wherein the second party is a party other than the at least one party operating a mobile telephone and the second party is other than a party initiating the call.

2. The method of claim 1, wherein the second party is a party to the telephone conversation.

3. The method of claim 1, wherein the second party is operating a mobile telephone.

4. The method of claim 1, wherein the second party is operating a telephone that is not a mobile telephone.

5. The method of claim 1, further comprising: receiving an indication from the second party; and responsive to the indication, performing the writing step.

6. The method of claim 5, wherein the indication includes a signal generated in response to the second party's actuating a control on a telephone.

7. The method of claim 1, further comprising:
connecting a telephone call from the at least one party operating a mobile telephone to the second party; and
responsive to connecting the telephone call, performing the writing step.

8. The method of claim 1, further comprising:
writing data to the billing record to indicate that the second party has been billed for additional charges of the at least one party operating a mobile telephone that are other than mobile telephone airtime charges.

9. The method of claim 8, wherein the additional charges include at least one of long distance charges, local toll charges, and local telephone call charges.

10. The method of claim 1, further comprising:
presenting an indication to the at least one party operating a mobile telephone that the at least one party operating a mobile telephone will not be billed for the mobile telephone airtime charges.

11. A method comprising:
receiving a request from a first party to accept charges accrued by a second party for a telephone call in progress; and
responsive to the request, writing data to a billing record to indicate that the first party has been billed for the telephone call.

12. The method of claim 11, wherein the charges include at least one of mobile telephone airtime charges, long-distance charges, and local telephone charges.

13. The method of claim 11, wherein the second party operates a mobile telephone.

14. The method of claim 11, wherein the second party operates a telephone that is not a mobile telephone.

15. The method of claim 11, wherein the indication includes a signal generated in response to the second party's actuating a control on a telephone.

16. A computer program product in a computer readable medium and operative with respect to a telephone conversation having at least one party operating a mobile telephone, comprising instructions for:
responsive to receiving an indication from a second party, writing data to a billing record to indicate that the second party has been billed for mobile telephone airtime charges of the at least one party operating a mobile telephone, wherein the second party is a party other than the at least one party operating a mobile telephone and the second party is other than a party initiating the call.

17. The computer program product of claim 16, wherein the second party is a party to the telephone conversation.

18. The computer program product of claim 16, wherein the second party is operating a mobile telephone.

19. The computer program product of claim 16, wherein the second party is operating a telephone that is not a mobile telephone.

20. The computer program product of claim 16, comprising additional instructions for:
receiving an indication from the second party; and responsive to the indication, performing the writing step.

21. The computer program product of claim 20, wherein the indication includes a signal generated in response to the second party's actuating a control on a telephone.

22. The computer program product of claim 16, comprising additional instructions for:
connecting a telephone call from the at least one party operating a mobile telephone to the second party; and
responsive to connecting the telephone call, performing the writing step.

23. The computer program product of claim 16, comprising additional instructions for:
writing data to the billing record to indicate that the second party has been billed for additional charges of the at least one party operating a mobile telephone that are other than mobile telephone airtime charges.

24. The computer program product of claim 23, wherein the additional charges include at least one of long distance charges, local toll charges, and local telephone call charges.

25. The computer program product of claim 16, comprising additional instructions for:
presenting an indication to the at least one party operating a mobile telephone that the at least one party operating a mobile telephone will not be billed for the mobile telephone airtime charges.

26. A computer program product in a computer readable medium, comprising instructions for:
receiving a request from a first party to accept charges accrued by a second party for a telephone call in progress; and
responsive to the request, writing data to a billing record to indicate that the first party has been billed for the telephone call.

27. The computer program product of claim 26, wherein the charges include at least one of mobile telephone airtime charges, long-distance charges, and local telephone charges.

28. The computer program product of claim 26, wherein the second party operates a mobile telephone.

29. The computer program product of claim 26, wherein the second party operates a telephone that is not a mobile telephone.

30. The computer program product of claim 26, wherein the indication includes a signal generated in response to the second party's actuating a control on a telephone.

31. A data processing system operative with respect to a telephone conversation having at least one party operating a mobile telephone, comprising:
a bus system;
a processing unit including at least one processor; and
a memory containing a set of instructions,
wherein the processing unit executes the set of instructions to perform the acts of:
responsive to receiving an indication from a second party, writing data to a billing record to indicate that the second party has been billed for mobile telephone airtime charges of the at least one party operating a mobile telephone, wherein the second party is a party other than the at least one party operating a mobile telephone and the second party is other than a party initiating the call.

32. The data processing system of claim 31, wherein the second party is a party to the telephone conversation.

33. The data processing system of claim 31, wherein the second party is operating a mobile telephone.

34. The data processing system of claim 31, wherein the second party is operating a telephone that is not a mobile telephone.

35. The data processing system of claim 31, wherein the processing unit executes the set of instructions to perform the additional acts of:
receiving an indication from the second party; and
responsive to the indication, performing the writing step.

36. The data processing system of claim 35, wherein the indication includes a signal generated in response to the second party's actuating a control on a telephone.

37. The data processing system of claim 31, wherein the processing unit executes the set of instructions to perform the additional acts of:
connecting a telephone call from the at least one party operating a mobile telephone to the second party; and
responsive to connecting the telephone call, performing the writing step.

38. The data processing system of claim 31, further comprising:
writing data to the billing record to indicate that the second party has been billed for additional charges of the at least one party operating a mobile telephone that are other than mobile telephone airtime charges.

39. The data processing system of claim 38, wherein the additional charges include at least one of long distance charges, local toll charges, and local telephone call charges.

40. The data processing system of claim 31, wherein the processing unit executes the set of instructions to perform the additional act of:
presenting an indication to the at least one party operating a mobile telephone that the at least one party operating a mobile telephone will not be billed for the mobile telephone airtime charges.

41. A data processing system comprising:
a bus system;
a processing unit including at least one processor; and
a memory containing a set of instructions,
wherein the processing unit executes the set of instructions to perform the acts of:
receiving a request from a first party to accept charges accrued by a second party for a telephone call in progress; and
responsive to the request, writing data to a billing record to indicate that the first party has been billed for the telephone call in progress.

42. The data processing system of claim 41, wherein the charges include at least one of mobile telephone airtime charges, long-distance charges, and local telephone charges.

43. The data processing system of claim 41, wherein the second party operates a mobile telephone.

44. The data processing system of claim 41, wherein the second party operates a telephone that is not a mobile telephone.

45. The data processing system of claim 41, wherein the indication includes a signal generated in response to the second party's actuating a control on a telephone.
